(19) United States
(12) Patent Application Publication
(10) Pub. No.: US 2013/0217808 A1
(43) Pub. Date: Aug. 22, 2013

(54) PRODUCTION OF COMB POLYMERS BY MEANS OF ESTERIFICATION

(71) Applicants: Ueli Sulser, Unterengstringen (CH); Lukas Frunz, Zurich (CH); Jorg Zimmermann, Winterthur (CH); Jurg Weidmann, Greifensee (CH)

(72) Inventors: Ueli Sulser, Unterengstringen (CH); Lukas Frunz, Zurich (CH); Jorg Zimmermann, Winterthur (CH); Jurg Weidmann, Greifensee (CH)

(73) Assignee: SIKA TECHNOLOGY AG, Baar (CH)

(21) Appl. No.: 13/879,527

(22) PCT Filed: Dec. 7, 2011
(86) PCT No.: PCT/EP2011/072057

§ 371 Date: Apr. 15, 2013

(30) Foreign Application Priority Data
Dec. 10, 2010 (EP) 10194535.0

(51) Int. Cl. C04B 24/26

(52) U.S. Cl. CPC C04B 24/2605
USPC 524/5; 525/330.1

(57) ABSTRACT

The invention relates to a method for producing comb polymers, wherein at least one polycarboxylic acid or a salt thereof is esterified with at least one monohydroxy polyether, comprising the following steps: (a) preparing a reaction mixture containing at least one polycarboxylic acid; (b) heating the reaction mixture to at least 80° C.; (c) adding a base; and (d) esterifying the mixture at a reaction temperature of at least 80° C. obtaining a comb polymer, wherein at least one monohydroxy polyether is added to the reaction mixture in step (a) and/or (b). The invention further relates to comb polymers, cement compositions, molded bodies, and uses of comb polymers.

The invention relates to methods for producing comb polymers by means of esterification. The invention also relates to comb polymers, comb polymer-containing compositions, hydraulically setting cement compositions and molded bodies, as well as uses of the comb polymers and comb polymer-containing compositions.

### PRIOR ART

Comb polymers of carboxylic acid polymers having polyalkylene glycol side chains are used as a dispersant in concrete technology, in particular as a plasticizer. Upon addition of such polymers to cements, the water content may be reduced, which is beneficial to processing and the stability of the concrete. The polymers are called comb polymers because they comprise a single base polymer (also referred to as “backbone”, “polymer backbone”, “backbone” or “main chain”) to which to a plurality of side chains is covalently bound, so that the overall molecular structure resembles a comb. There are a number of such comb polymers, which, besides ester groups and free carboxyl groups, may include, inter alia, amide groups.

In the prior art, essentially two methods are used for producing comb polymers. In a common method such comb polymers are produced by radical polymerization from unsaturated carboxylic acid, ester, ether, amide and/or imide functional monomers. In another known method, the polymers are produced in a so-called “polymer-analogous reaction” from a polycarboxylic acid having acrylic acid moieties and/or methacrylic acid moieties and the respective alcohols and/or amines. Here, the comb polymer is obtained by esterification and/or amidation of the polycarboxylic acid or a salt or anhydride thereof.

Comb polymers, which are used as plasticizers for cement compositions contain, as main side chains, generally polyethers, which are linked via ester groups to the polycarboxylic acid. Producing the comb polymers by polymer-analogous reaction thus includes an esterification as the essential reaction step. Since esterification reactions in organic synthesis is usually carried out by means of acid catalysis, in the prior art, producing comb polymers from monohydroxy polyethers having a terminal hydroxy group, and polycarboxylic acid is also carried also by acid catalysis.

In this context, EP 2065403 A1 discloses the acid-catalyzed esterification of polycarboxylic acids with monohydroxy polyethers in the presence of strong mineral acids, preferably sulfuric acid.

EP 1138697 A1 also discloses the esterification of polyacids with monohydroxy polyethers in the presence of acid catalysts. Sulfuric acid or p-toluenesulfonic acid are used as preferred catalysts. To neutralize the polyacid, optionally alkaline substances can be added, such as metal hydroxides.

In WO 99/47468 it is proposed that in the esterification of the polycarboxylic acids a base such as sodium hydroxide and lithium hydroxide is added to the reaction mixture. It is disclosed that comb polymers produced in this manner have advantageous properties in plasticizing cement compositions. However, in such reaction mixtures, the components cannot, or only with great difficulty, be mixed homogeneously. The components form of phases, or precipitate, whereby the synthesis yield will be adversely affected or in the extreme case, the reaction is not feasible.

In view of the global construction activity, there is a significant need for such plasticizers for concrete. The comb polymers previously described are composed of comparatively complex structure and the synthesis is correspondingly sophisticated. Thus, in order to keep costs low in concrete processing, there is a need for new and efficient methods for producing such comb polymers. Especially in the production on an industrial scale, it is desirable to improve known methods in terms of reaction time, energy efficiency and yield.

Moreover, it is still a challenge to provide plasticizers for different processing conditions, which are used worldwide for the production of concrete. This is due to the different types of local climates, cements, aggregates, cement replacement fillers, etc., and the different products, such as ready-mixed concrete, transit-mixed concrete, shotcrete, self-compacting concrete or concrete mixed on site. Special additives must therefore be provided that are effective under completely different conditions There is therefore a need for new additives, which can be used as dispersants, in particular as plasticizers for hydraulically setting systems, and particularly for new fields of application.

Following the esterification reaction, a reaction product is obtained in the form of a melt of the comb polymer, which in addition contains by-products, unreacted starting materials, and salts. These other components can affect the stability of the comb polymer and its effect as a plasticizer. In the prior art, optionally a post-treatment is carried out, for example by neutralization or dilution. Usually, there will be no purification of the comb polymer, since such processing methods in industrial production would be too expensive and not cost-economical. Thus, usually there is no separation of by-products or salts, for example, by dialysis or column chromatography.

In principle, it would therefore be desirable to obtain the comb polymers of high purity, in high yields and with low levels of unwanted by-products.

Disadvantageously, known comb polymer-containing compositions are prone to hydrolysis. This may change the content of the comb polymer during storage or use and the effect as a plasticizer may be reduced.

Another disadvantage is a high salinity (salt load) of the reaction product. This can cause precipitation during storage, in particular at low temperatures. The salt load of the reaction product is a result in part from the inorganic acid or basic catalysts and additives and, optionally, from the used polycarboxylic acid, if it is used as a salt.

### OBJECT OF THE INVENTION

The invention is based on the object to overcome the above described problems.

There will be provided a simple and efficient method for producing comb polymers. The method will proceed economically, using small amounts of reactants and additives and in a few reaction steps and achieve a high yield with a short reaction time and low power consumption.

Another object of the invention is to provide comb polymers and comb polymer-containing compositions having advantageous properties. The content of the comb polymer in the reaction product will therefore be high and the content of undesirable by-products low. The comb polymer, or the solution containing the comb polymer are not prone to hydrolysis and have good stability during storage and processing. In particular, the salt load will be low.

Thus, new plasticizers for use in setting compositions will be provided having advantageous properties. In hydraulically setting compositions, the polymers will show a good plasticizing effect.

### DISCLOSURE OF THE INVENTION

Surprisingly, the object underlying the invention is achieved by methods according to the claims.

The invention provides a method for producing comb polymers, wherein at least one polycarboxylic acid or a salt thereof is esterified with at least one monohydroxy polyether, comprising the following steps:
(a) preparing a reaction mixture containing at least one polycarboxylic acid;
(b) heating the reaction mixture to at least 80° C., particularly above 100° C.;
(c) adding a base; and
(d) esterifying at a reaction temperature of at least 80° C., particularly above 100° C., obtaining a comb polymer,
   wherein at least one monohydroxy polyether is added to the reaction mixture in step (a) and/or (b).

Particularly, the steps (a)-(d) are carried out in the order specified.

In the method of the invention, the base is added in an amount which causes a partial neutralization of the polycarboxylic acid. Surprisingly, it was found that upon heating the reaction mixture to above 80° C., preferably above 100° C. or above 120° C., and subsequent addition of a base for partial neutralization of the polycarboxylic acid, the reaction is particularly efficient.

In step (a), there is provided a reaction mixture. The reaction mixture contains said at least one polycarboxylic acid, in particular as an aqueous solution, and optionally at least one monohydroxy polyether. Here, initially, only a portion of the monohydroxy polyether may be added or the entire amount. Optionally, additional acids and/or monoamine compounds are present. Said monohydroxy polyether, or part of the total amount of said monohydroxy polyether, said additional acid and/or said monoamine compounds may also be added at a later time during or after the heating of the reaction mixture. Particularly, said additional acid is added at no more than 100° C. This can be advantageous when the mixture at low temperature is relatively viscous and is difficult to homogenize. Usually, the reaction mixture is aqueous. Preferably, the reaction mixture in step (a) and (b) is mixed homogeneously, for example, by stirring. The base is not yet added to the reaction mixture in step (a) and (b). The temperature of the reaction mixture in step (a) can be, for example, between 25° C. and 90° C. Preferred is a temperature above room temperature, because then the mixing of the components is easier, for example at 40° C. ° to 80° C.

Preferably, in the reaction mixture in step (a) and/or (b) the polycarboxylic acid is not or not substantially present in neutralized form. The protonated or non-neutralized form of the carboxyl group has the formula —COOH, while the neutralized or non-protonated form has the formula —COO⁻. It was found that a completely or largely protonated polycarboxylic acid can be mixed particularly efficiently and homogeneously. In the present invention, “substantially” or “largely” in terms of terms such as “protonated” or “neutralized” means that the polycarboxylic acid is present at more than 90%, in particular more than 92%, in particular more than 95% in protonated or neutralized form.

In contrast, in neutralized and/or partially neutralized polycarboxylic acids it was observed that in the reaction mixture inhomogeneities may form and that the reaction is less efficient or in extreme cases not at all feasible.

In one embodiment of the invention, therefore, prior to the heating in step (b) an additional acid, in particular sulfuric acid or p-toluenesulfonic acid, may be added to the reaction mixture in step (a). Here, the additional acid is added in an amount such that the polycarboxylic acid is completely or substantially protonated and is present no longer, or substantially no longer in neutralized form.

Preferably, said additional acid is a strong acid, such as a mineral acid. Preferably, the pKa of said additional acid is less than 3, in particular less than 1. Preferred additional acids are sulfuric acid and p-toluenesulfonic acid.

The addition of an additional acid may be advantageous to dissolve and to homogenize the reaction mixture. This is particularly advantageous when the polycarboxylic acid used is present in completely or partially neutralized form. Said additional acid serves to protonate the polycarboxylic acid in the reaction mixture. This improves the miscibility with the other components, in particular when the reaction mixture is heated, causing the water content to be reduced. Said acid acts as a solubilizer for the monohydroxy polyether and the polycarboxylic acid. The addition of additional acid is particularly preferred when the reaction mixture shows inhomogeneities. If no complete mixing of monohydroxy polyether and the polycarboxylic acid is achieved, it may have a negative impact on the reaction rate and reaction control. The amount of said additional acid used is, for example, 1 to 400 mmol, in particular between 2 and 100 mmol, based on 1 mol of carboxyl groups of the base polymer. Here, the equivalent concentration of the acid is preferably lower than that of the base. It is, for example, 0.05 to 0.8 equivalents, preferably 0.1 to 0.5 equivalents, based on the base. Preferably, following the addition of said additional acid, the polycarboxylic acid is completely or largely protonated.

The addition of said additional acid in step (a) is not required if the reaction mixture is mixed homogeneously without this acid during mixing and heating. Particularly, this is the case when the polycarboxylic acid used is present in slightly or not neutralized form. In this preferred embodiment, no additional acid, in particular, no mineral acid is added.

For example, in the reaction mixture in step (a) the polycarboxylic acid is protonated more than 95%, particularly more than 98%, more than 99% or more than 99.5%. The degree of neutralization and protonation of the polycarboxylic acid can be determined by known methods, for example by titration.

The polycarboxylic acid or the salt thereof forms the base polymer (“polymer backbone”, “backbone”) of the comb polymer. In a preferred embodiment of the invention, the polycarboxylic acid is a polyacrylic acid, polymethacrylic acid or a copolymer of acrylic acid and methacrylic acid. The polycarboxylic acid may be present as free acid or as a salt, whereby there may be only a part of the acid groups present in salt form. The polycarboxylic acid is then neutralized completely or partially. According to the invention, in addition to the classical salts which are obtained by neutralization with a base, the term “salt” includes also complex compounds with metal ions and the carboxylate groups as ligands. In producing such polycarboxylic acids, the adjustment of the chain length is effected by a modifier, such as phosphite or sulfite. Therefore, the polycarboxylic acids may have groups that are not acid moieties, such as phosphorus or sulfur-containing groups. Suitable polycarboxylic acids are commercially available and are available, for example, from BASF under the trade name “Sokalan”.

The monohydroxypolyethers has one hydroxyl group per molecule, which preferably is terminal. Thus, the polyethers are monohydroxy-terminated polyethers. Such monohydroxy polyethers are generally capped at one end by end groups that are not reactive under typical reaction conditions, preferably alkyl groups. Preferably, said monohydroxy polyethers are monohydroxy alkoxylates. Preferably, it is a polymer having a polyalkylene backbone. Preferably, said monohydroxy polyether is a monohydroxy compound E of the formula (I)

HO—(R³O)ₓ—R⁴ (I),

wherein each of R³ is independently a C₂-C₄ alkylene group with an order of the (R³O) moieties in any sequence, wherein R⁴ is a C₁-C₁₂ alkyl or cycloalkyl radical, a C₇-C₂₀ alkylaryl or aralkyl radical, or a substituted or unsubstituted aryl radical, or a monovalent organic radical having 1 to 30 carbon atoms which optionally comprises heteroatoms; and wherein x is a number from 3 to 250, preferably 5 to 200, and typically designates the average chain length.

Preferably, monohydroxy compounds E of the formula (I) have an alkyl group as the substituent R⁴. Preferably, this is a methyl, ethyl, i-propyl or n-butyl group, particularly a methyl group or ethyl group. Preferably, each of R³ is independently a C₂ alkylene group and/or a C₃ alkylene group. Preferably, E is mixed polymers of ethylene oxide/propylene oxide, more preferably a one-sided end-capped polyoxyethylene. Mixtures of several different compounds of group E are also possible. For example, one-sided end-capped polyoxyethylenes having different molecular weights may be mixed, or, for example, mixtures of one-sided end-capped polyoxyethylenes with one-sided end-capped mixed polymers of ethylene oxide and propylene oxide, or one-sided end-capped polyoxypropylenes may be used.

In a preferred embodiment, the monohydroxy compound E is a one-sided end-capped polyoxyalkylene having a molecular weight M_{w} from 500 to 10,000 g/mol, in particular from 800 to 8000 g/mol, preferably from 1000 to 7000 g/mol. Also suitable is a mixture of one-sided end-capped polyoxyalkylenes having different molecular weight, for example, the mixture of polyoxyalkylene having a molecular weight of 1,000 g/mol and polyoxyalkylene having a molecular weight of 5,000 g/mol.

The amount of monohydroxy polyether is set so that the desired degree of esterification of the base polymer is achieved. In a preferred embodiment of the invention the degree of esterification of the polycarboxylic acid, which is the ratio of the number of ester groups to the number of all the carboxyl groups of the base polymer in the unesterified state, is between 5 and 80%, preferably between 9 and 67%, more preferably between 13-50%.

In a preferred embodiment of the invention, the polycarboxylic acid is amidated with at least one additional amine. Preferably, the amidation takes place with the esterification. In addition to the monohydroxy compound E, a monoamine compound F may be added to the esterification. In doing so, the formation of amide groups takes place in addition to the esterification. Typical examples of such monoamine compounds F can be represented by the formula (II):

NH₂—(R³O)ₓ—R⁴ (II).

Each of the substituents R³ and R⁴, and the index x, respectively, independently of one another have the same meanings as already defined above for formula (I).

Examples of such monoamine compounds F are α-methoxy-ω-amino polyoxyethylene, α-methoxy-ω-amino polyoxypropylene, and α-methoxy-ω-amino oxyethylene oxypropylene copolymer. Particularly preferred monoamine compounds F are α-methoxy-ω-amino oxyethylene oxypropylene copolymers, or α-methoxy-ω-amino polyoxyethylenes, and other monoamines, which are sold, for example, by Huntsman under the name Jeffamine(R) M Series, as well as mixtures thereof. Most preferred are α-methoxy-ω-amino oxyethylene oxypropylene copolymers. Such monoamine compounds F are available, for example from an alcohol-initiated polymerization of ethylene and/or propylene oxide, followed by conversion of the terminal alcohol group to an amine group.

The amount of the monoamine compound used is set such that the desired degree of amidation of the base polymer is achieved. Preferably, the comb polymer has a proportion of amide groups of 0.01 to 2%, preferably between 0.02 and 0.2%, based on the total number of carboxyl groups of the base polymer prior to the reaction. Preferably, the proportion of said amide groups is about 0.04%.

Preferably, the esterification, optionally in conjunction with an amidation, takes place by the reaction of
a) at least one polycarboxylic acid or a salt of said polycarboxylic acid;
b) at least one monohydroxy compound E of the formula (I)

HO—(R³O)ₓ—R⁴ (I)
and optionally at least one additional monoamine compound F of the formula (II)

NH₂—(R³O)ₓ—R⁴ (II)

wherein each of x, R³ and R⁴ is independently selected as specified above.

In the esterification a further compound D can be added, which can react with said polycarboxylic acid or the salt thereof. Examples of a compound D are other amines or alcohols, for example a C₆-C₂₀ alkyl alcohol, or another mono- or diamine, preferably monoamine. Also, several different compounds D may be used.

Prior to addition of the base, the reaction mixture is heated in step (b) to a temperature above 80° C. The temperature set in step (b) preferably corresponds to the reaction temperature of the esterification in step (d). Preferably, the temperature in step (b) and/or the reaction temperature in step (d) is at least 100° C. or at least 120° C., more preferably at least 140° C. or at least 160° C. In preferred embodiments, the temperature in step (b) and/or the reaction temperature in step (d) are between 80° C. and 250° C., preferably between 120° C. and 220° C. or between 140° C. and 200° C. A preferred temperature is 175° C., for example. In step (b), in particular, temperatures above 100° C. are preferred because in doing so water can be efficiently removed.

Following heating in step (b), and in particular prior to performing the actual esterification, a base is added to the reaction mixture in step (c) of the method. Said base is added to the reaction mixture after the polycarboxylic acid was mixed with the monohydroxy polyether. Here, the base is an additional component of the reaction mixture. The polycarboxylic acid used as a starting material or other starting materials, for example, the amine used for amidation, is not an additional base for the purposes of the invention.

Preferably, the base is a low molecular compound. This means, preferably, that the base is not a polymer, that is, not a compound produced by a polymerization reaction. The molecular weight is, for example, below 2000 g/mol or less than 1000 g/mol.

The base is preferably selected from metal carboxylates, metal hydroxides, metal carbonates, thiocyanates, and phosphites. In a preferred embodiment of the invention the metal of the base is an alkali metal or alkaline earth metal, particularly sodium or potassium. In a preferred embodiment of the invention, the carboxylate is a carbonate, formate, acetate, propionate, citrate, adipate, maleate or tartrate. Preferably the carboxylate is a sodium or potassium carboxylate, particularly an acetate or formate. Preferably, potassium salts are used.

The base is used to neutralize the polycarboxylic acid in the reaction mixture, at least partially. Preferably, the degree of neutralization of the polycarboxylic acid in the reaction mixture after addition of the base in step (c) is between 2% and 50%, preferably between 4% and 30%, more preferably between 5% and 20% or between 5% and 15%.

The skilled artisan knows that an esterification reaction is an equilibrium reaction, which depends on the concentrations of the reactants and the pH value. Therefore, the amount of the base used, the quantities of the starting materials and the pH value are set with respect to each other such that an efficient reaction takes place.

Preferably, the pH of the reaction mixture during the reaction in step (d) is slightly acidic, in particular between 3 and 6, or between 3 and 5.5. Preferably, the pH is above 3, in particular above 3.5.

The reaction also dependents on the water content of the reaction mixture. Generally, the reaction is promoted when the water content is low. If the water content in the reaction mixture is too high, because the starting materials are provided in the form of aqueous solutions or dispersions, for example, a portion of the water should be removed before carrying out the reaction. Preferably, the water content is reduced in step (b) by heating, wherein the distilled water is being removed. Optionally, before adding the base in step (c), the reaction mixture may be left at an elevated temperature, until the desired water content is reached.

The amount of the base used in step (c) is set in consideration of the degree of neutralization of the polycarboxylic acid. Often, polycarboxylic acids are commercially available in partially or completely neutralized form. As explained above, prior to heating in step (b), said polycarboxylic acid should be present in strongly or largely protonated form which optionally may be accomplished by adding acid.

In a preferred embodiment, the base is added in an amount of 10 to 500 mmol, preferably from 20 to 150 mmol, in particular between 25 and 100 mmol, based on 1 mol of carboxyl groups of the polycarboxylic acid used.

In a preferred embodiment of the invention, the base is a metal carboxylate, wherein the carboxylate is removed by distillation during or after the esterification in the form of the carboxylic acid. The removal of the base anions by distillation is possible with the use of formates, acetates or carbonates, where the corresponding acid is distilled off. As a result of the reduced salt load of the reaction products, the comb polymer-containing reaction products have an increased stability on storage. Particularly, an improvement in storage at low temperatures can bee seen, for example between 0 and 15° C. It has been found that such comb polymers are less prone to precipitation of salts than comb polymer solutions produced in accordance with the prior art.

According to the invention, a phosphite may be used as a base. Prior to the reaction, the phosphite can be added to the mixture of polycarboxylic acid and polyether. In the prior art, polycarboxylic acids are generally produced with a molecular weight modifier to adjust the chain length. Among other things, phosphites are used as modifiers. Such a phosphite-containing reaction product can then be esterified according to the invention.

According to the invention it is particularly preferred to use at least one salt of an organic acid as the base. In general, such bases are weak bases with relatively low pK_{B} values. In this embodiment the use of metal hydroxides, particularly alkali or alkaline earth metal hydroxides is not necessary. In an embodiment, no metal hydroxide, in particular, no alkali or alkaline earth metal hydroxide, is added to the reaction mixture. The addition of basic amines, for example as catalysts, is also not necessary. Preferably, no amines are added as a base.

In a preferred embodiment of the invention, in addition to the base polymer, the reaction mixture contains the following components, based on 1 mol of carboxyl groups of the base polymer:
(A) 0.05 to 0.8 mol of monohydroxy polyether,
(B) optionally 0 to 0.5 mol of amines,
(C) 10 to 250 mmol of additional base; and
(D) optionally 0 to 100 mmol of additional acid.

In a further embodiment of the invention, the reaction mixture contains
(E) up to 30% by weight, preferably less than 20% by weight water, based on the total weight of components (A), (B), and the base polymer and the polymer backbone, respectively.

The reaction of the polycarboxylic acid or salt thereof with the monohydroxy polyether and optionally at least one additional monoamine compound F and optionally with a further compound D to form a comb polymer is carried out in the polymer-analogous reaction typically such that, the at least one monohydroxy compound E and/or the at least one monoamine compound F is added to the polycarboxylic acid or the salt thereof, and it is heated to the reaction temperature. Subsequently, the base is added. The mixture is further stirred and reacted possibly under vacuum, or by passing a gas stream over or through the reaction mass. If a monoamine compound F is used in addition to the monohydroxy compound E, it may be added simultaneously with the monohydroxy compound E or at a later stage during this reaction step.

At the reaction temperature, the reaction mixture is a viscous mass, which can also be described as a melt. Overall, the base must be selected such that it is sufficiently soluble under the desired reaction conditions. It has been found that the preferred bases of the invention, such as carboxylates and metal hydroxides, can be used in sufficient amounts under the reaction conditions (elevated temperature, low water content) owing to their solubility.

Conventional additives may be added, which are advantageous for esterification. Preferably, for example, a defoamer is added.

After completion of the esterification reaction, the reaction can be stopped by cooling. In principal, the reaction of the invention is so efficient that a nearly complete conversion is achieved and a neutralization is not essential. According to the invention, it is sufficient to cool the reaction mixture. Regardless, the reaction mixture may be worked up.

Preferably, the reaction is carried out under reduced pressure. The reaction of the invention is carried out by means of conventional devices, in particular with stirring, by means of temperature control, using conventional heating devices and/or with a suitable vacuum pump.

According to the invention, it was found that with the addition of bases, high yields of the comb polymers can be achieved. Preferably, the degree of conversion, based on the polyether used, is above 70%, 80% or 90%, preferably above 95%.

Since the reaction proceeds particularly rapidly and efficiently, a relatively low reaction time can be set. Preferably, the reaction time is between 30 minutes and 6 hours, in particular between 45 and 240 minutes. For example, when using potassium acetate as the base, the nearly complete conversion of the monohydroxy polyether can be reached within an hour. Compared to known methods, due to its high efficiency, the method of the invention therefore saves energy and cost. In large-scale production of comb polymers, a large amount of energy can be saved, because the reaction time at high temperature (significantly over 100° C.) is reduced. Also, the reaction temperature can be significantly reduced compared to known methods.

According to the invention, a comb polymer-containing melt is obtained. It contains the comb polymer in a high purity and concentration. Upon cooling of the melt, the comb polymer may be obtained in solid form, particularly in the form of flakes. When mixed with water, a solution can be obtained also. Optionally, the reaction product may be post-treated, for example, neutralized or can be provided with accessory agents and/or additives, and used as an additive to hydraulically setting compositions.

The subject of the invention is also a comb polymer-containing composition, which can be obtained by the method of the invention. The composition is the reaction product and, therefore, an aqueous solution or dispersion of the comb polymer. It can also contain further components, such as unreacted starting materials, by-products, salts and optionally additives.

In a preferred embodiment of the invention, the comb polymer comprises:
a) at least one acrylic acid moiety A, or a salt thereof and/or at least one methacrylic acid moiety M, or a salt thereof;
b) at least one structural moiety B of the formula (I);

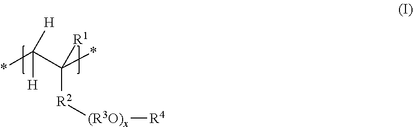

wherein
R¹ each independently represents a H or CH₃;

R² each independently represents an ester group —CO—O— or an amide group —CO—NH—,
R³ each independently represents a C₂-C₆ alkylene group, in particular an ethylene or propylene group,
R⁴ each independently represents H, a C₁-C₁₂ alkyl or cycloalkyl radical, a C₇-C₂₀ alkylaryl or aralkyl radical, or a substituted or unsubstituted aryl radical, or a monovalent organic radical having 1 to 30 carbon atoms which optionally comprises heteroatoms; and
x each independently is a value of between 3 and 250, preferably between 5 and 200.

Here, the main chain or the base polymer of the comb polymer is a linear polymer or copolymer, which was obtained by polymerization from the at least one acrylic acid moiety A or the salt thereof and/or the at least one methacrylic acid moiety M or the salt thereof. The structural moiety B is part of the comb polymer.

Said at least one acrylic acid moiety A and said at least one methacrylic acid moiety M can be partially or completely neutralized. The acid moiety may be present as free acid or as a salt or partial salt or as an anhydride, wherein the term “salt” here and in the following comprises, in addition to the classical salts, such as are obtained by neutralization with a base, also complex-chemical compounds between metal ions and the carboxylate or carboxyl groups as ligands. The classical salts are obtained in particular by neutralization with sodium hydroxide, calcium hydroxide, magnesium hydroxide, ammonium hydroxide or an amine.

The structural moiety B of the formula (I) may be an ester or an amide depending on the selection of the R² group. The comb polymer contains ester groups and optionally additional amide groups. Here, the proportion of the structural moieties B that are connected via ester groups is preferably at least 50%, in particular at least 80% or at least 90%, or 100%.

The base polymer of the comb polymer may be, depending on the selection of a) and b), a polyacrylic acid or a polymethacrylic acid or a copolymer of acrylic acid and methacrylic acid.

In a preferred embodiment, —(R³O)ₓ— represents a C₂ to C₄ polyoxyalkylene group, in particular a polyoxyethylene group or a polyoxypropylene group, or mixtures of oxyethylene and oxypropylene moieties in any sequence, for example, random, alternating or blockwise. Preferably, R⁴ is not H, and particularly preferably a methyl radical.

In a preferred embodiment of the invention, the comb polymer has a portion of ethylene oxide moieties of at least 30 mol %, preferably 50 to 100 mol %, in particular 80 to 100 mol %, based on the total number of all (R³O)ₓ moieties. Particularly preferably, ethylene oxide moieties exclusively are present in the comb polymer.

In a preferred embodiment of the invention, the comb polymer has at least one further structural moiety C, which is different from the structural moieties A, B and M, and which is selected from an ether, ester, amide or imide moiety, an acid moiety, selected from carboxylic acid, sulfonic acid, phosphonic acid, phosphoric acid esters, carbonylamidomethylpropanesulfonic acid and their salts or a polyoxyalkylene oxycarbonyl, polyoxyalkylene aminocarbonyl, polyoxyalkylene oxyalkyl, polyoxyalkylene oxy, Hydroxyethyl oxycarbonyl, acetoxy, phenyl- or N-pyrrolidonyl group. Preferably, said further structural moiety C includes polyoxyalkylene groups, preferably polyoxyethylene groups, polyoxypropylene groups or mixtures thereof. For example, the structural moiety C may be an ester moiety which is produced by reacting a mono- or dicarboxylic acid with an alkyl alcohol, in particular a C₆-C₂₀ alkyl alcohol.

The comb polymer may have a combination of different structural moieties of the respective structural moieties of A, M, B and optionally C. For example, in the comb polymer a mixture of several acid moieties A and M may be present, which are not at all or completely neutralized. Alternatively, in the comb polymer a mixture of several different ester and/or amide moieties B may be present, for example, ester moieties B with different substituents R³. For example, the combined use of polyoxyalkylenes, in particular polyoxyethylene together with polyoxypropylene, or the combined use of polyoxyalkylenes, in particular polyoxyethylenes having different molecular weight is preferred.

In a preferred embodiment of the invention, the comb polymer comprises
a) 5 to 95 mol %, preferably 10 to 80 mol %, particularly preferably 50-70 mol % of acrylic acid moieties A and/or 5 to 95 mol %, preferably 10 to 80 mol %, particularly preferably 50-70 mol % methacrylic acid moieties M,
b) 5 to 50 mol %, preferably 10 to 40 mol % of the structural moiety B, and
c) 0 to 30 mol %, preferably 0 to 15, in particular 0 to 5 mol % of the structural moiety C,
   each based on the total number of monomeric moieties in the main chain of the comb polymer.

The sequence of the individual structural moieties A, M, B, and C in the comb polymer may be alternating, statistic or blockwise.

Preferably, the comb polymer has an average molecular weight Mₙ in the range of 6,000 to 150,000 g/mol, preferably 10,000 to 100,000 g/mol, particularly preferably 15,000 to 80,000 g/mol.

Another subject of the invention is a hydraulically setting cement composition comprising at least one comb polymer-containing composition of the invention and at least one hydraulically setting binder.

A further subject of the invention is a molded body which can be obtained by setting and curing of a setting cement composition of the invention. According to the invention, the term “molded bodies” refers to three-dimensional cured bodies that have received a shape, such as components, floors, coatings, etc.

A further subject of the invention is the use of a comb polymer-containing composition of the invention for plasticizing hydraulically setting compositions, in particular cement compositions. Here, the use of the direct reaction product of the esterification reaction, which was not further purified, is preferred. Because of the high concentration and stability of the comb polymers of these aqueous compositions, a purification is not necessary. In use, however, other components may be added, or the composition may be purified.

The term “hydraulically setting composition” is understood to mean compositions that contain hydraulically setting binders. Such binders cure in the presence of water. Suitable compositions and binders are known to those skilled in the field of construction chemistry. In a preferred embodiment of the invention, the hydraulic binder is selected from the group consisting of cement, gypsum, for example in the form of anhydride or hemihydrate, burnt lime, and mixtures of cement with fly ash, silica fume, slag, slag sand or limestone filler.

Cement and gypsum, respectively, are particularly preferred as the hydraulically setting composition. Conventional cements include, for example, Portland cement or alumina cements and their respective mixtures with conventional additives.

Optionally, accessory agents and/or additives are included as component (c). Said hydraulically setting compositions may contain conventional additives such as fly ash, silica fume, slag, slag sand or limestone filler. Furthermore, aggregates such as sand, gravel, stone, quartz powder, chalk, and components typically used as additives such as other concrete plasticizers, such as lignosulfonates, sulfonated naphthalene-formaldehyde condensates, sulfonated melamine-formaldehyde condensates or polycarboxylate ethers, accelerators, corrosion inhibitors, retardants, shrinkage reducing agents, defoamers or pore-forming agents are possible.

The comb polymer-containing composition may be used as a dispersant or as a component of a dispersant. The dispersant may contain other components such as additives, such as other plasticizers, for example, lignosulfonates, sulfonated naphthalene-formaldehyde condensates, sulfonated melamine-formaldehyde condensates or other polycarboxylate ethers (PCE), accelerators, retardants, shrinkage reducing agents, defoamers or air pore-forming agents, or foaming agents. Typically, the proportion of the comb polymer is 5 to 100% by weight, in particular 10 to 100% by weight, based on the total weight of the dispersant.

Depending on the reaction conditions, in addition to the comb polymer, the dispersant may contain free compounds of the starting materials, in particular free monohydroxy compounds such as, for example, one-sided end-capped polyoxyalkylene, and in particular free methoxy polyoxyethylene.

The dispersant may be used, in particular, as a plasticizer, as water reducer, to improve the processability and/or to improve the flowability of the hydraulically setting compositions produced therewith. In particular, using the dispersant hydraulically setting compositions with extended processability may be produced.

In the use of the invention hydraulically setting compositions show an extended processability. This means that following the addition of water and dispersing agent comprising the comb polymer, the composition remains processable over a comparatively long period, as compared to compositions that do not contain the comb polymer, or as compared to compositions containing other water-reducing additives, such as conventional plasticizer. The comparison is made, for example, such that the compositions without comb polymer or having a known plasticizer initially have the same water/cement ratio (w/c ratio) with comparable initial flow spread, which is set by the dosage of the plasticizer used for comparison.

Preferably, the comb polymer is used in an amount of 0.01 to 5% by weight, in particular 0.05 to 2% by weight or 0.1 to 1% by weight, based on the weight of the binder. The comb polymer may be added separately or as a comb polymer-containing composition in solid or liquid form. Preferably, the comb polymer is used in form of a liquid composition, in particular as an aqueous solution.

The comb polymer or comb polymer-containing composition may also be used in the solid state, for example as flakes, powders, scales, pellets, granules, or disks. Such solid additives can be easily transported and stored. In the solid state, the comb polymer may be a component of a so-called dry batch, for example, a cement composition, which can be stored for a long time and is typically packed in bags or stored and used in silos. Such a dry batch can also be used after an extended period of storage, and has a good flowability.

The comb polymer may be added to a hydraulically setting composition together with or shortly before or shortly after the addition of the water. Particularly suitable in this case proved the addition of the comb polymer in the form of an aqueous solution or dispersion, in particular as the mixing water, or as part of the mixing water. In particular, the preparation of the aqueous solution is carried out by subsequent mixing with water.

Also, the comb polymer may be added to a hydraulically setting composition, however, before or during its grinding operation, for example, the grinding of cement clinkers to form cement.

The method of the invention and the comb polymer-containing reaction products solve the objects underlying the invention. Because of the good mixing of the components, the method of the invention requires in total a relatively short reaction time and therefore is energy efficient.

As a result of the high yields of comb polymers of the invention, the reaction product of the invention has a low content of undesirable by-products and unreacted starting materials. For example, when using potassium acetate as the base, the nearly complete conversion of the polyether can be reached within an hour. This means, conversely, that the reaction mixture contains almost no free polyether and no or only few unwanted byproducts. According to the invention, therefore, comb polymer-containing compositions are obtained which exhibit an improved plasticizing effect in hydraulically setting compositions. The improvement of the plasticizing effect is important in cement compositions, as the water content of the cement can be reduced.

The comb polymer-containing compositions have a high stability. In particular, the method of the invention provides hydrolysis-resistant reaction products and comb polymers. Furthermore, the salt load of the reaction product can be reduced, in particular, if distillable bases are used, which are removed from the reaction mixture during or after the reaction.

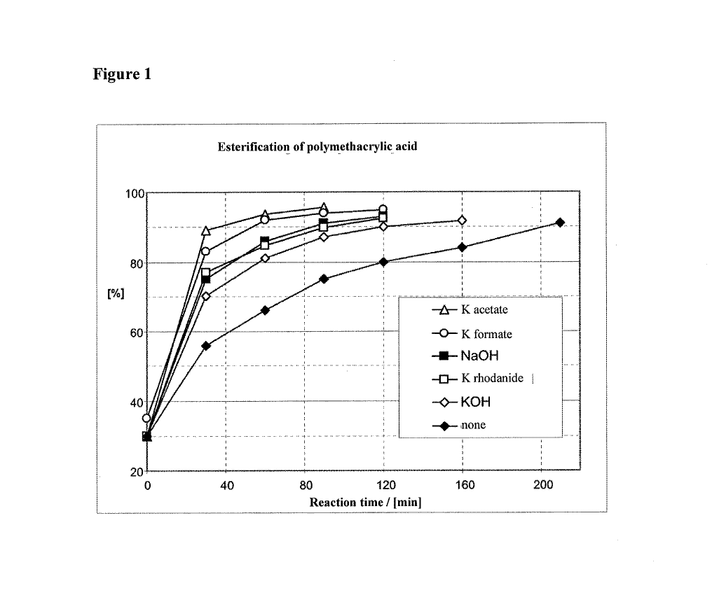

FIG. 1 shows the conversion in the esterification of polymethacrylic acid (as a percentage, based on the sum of the carboxyl groups of PMA) as a function of the reaction time in the presence of various bases.

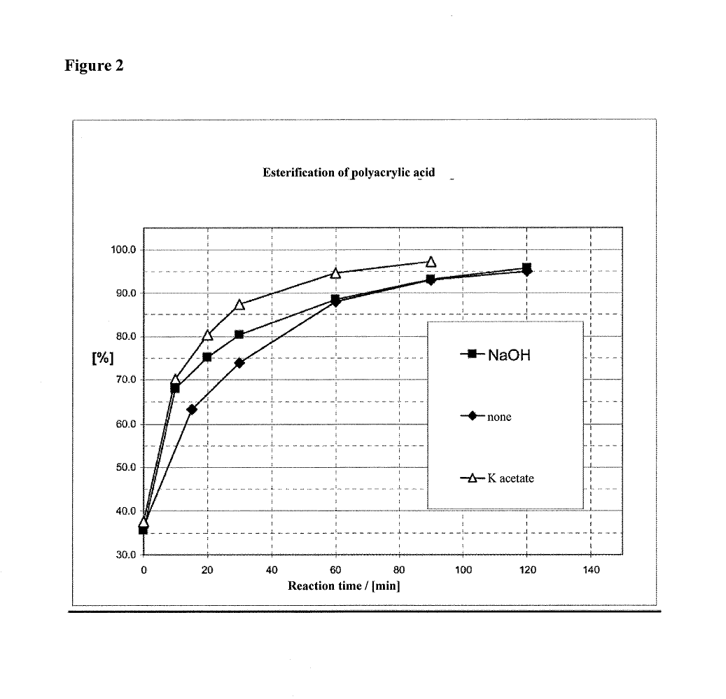

FIG. 2 shows the conversion in the esterification of polyacrylic acid (as a percentage, based on the sum of the carboxyl groups of PAS) as a function of the reaction time in the presence of various bases.

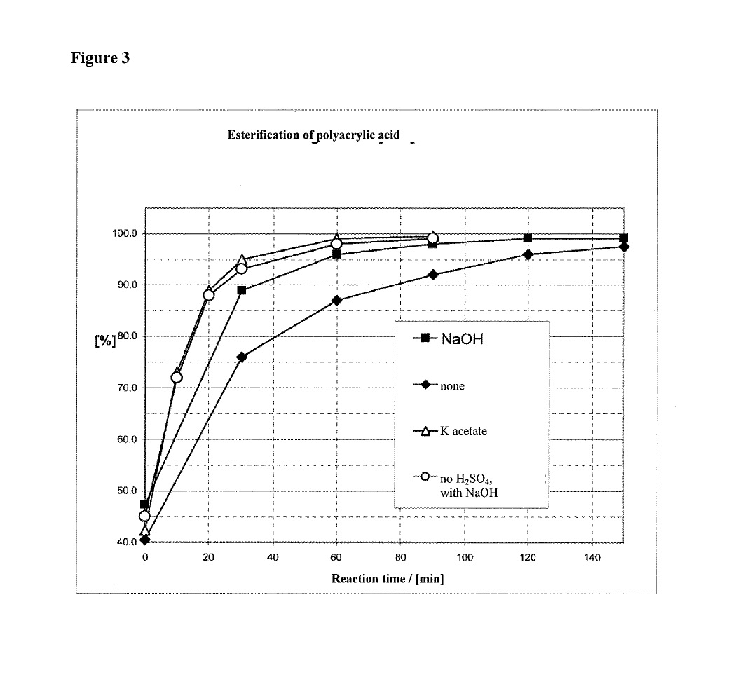

FIG. 3 shows the conversion in the esterification of polyacrylic acid (as a percentage, based on the sum of the carboxyl groups of PAS) as a function of the reaction time in the presence of various bases

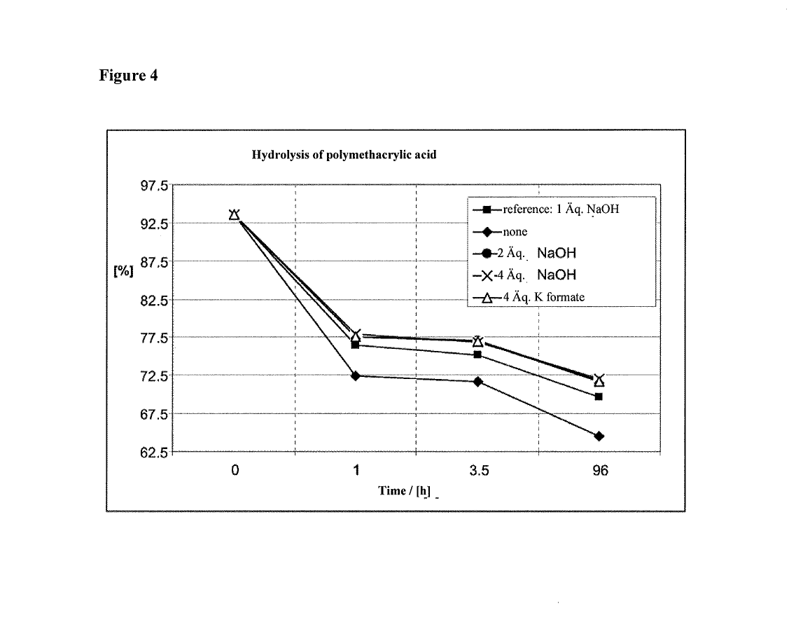

FIG. 4 shows the conversion of different comb polymers with a base polymer of polymethacrylic acid in the hydrolysis (in percent, based on the mass of the polymer prior to the start of the hydrolysis reaction) as a function of the reaction time.

### EMBODIMENTS

### Examples 1 to 11

### Esterification of Polymethacrylic Acid Using Various Bases

A 1000 ml reaction vessel equipped with a mechanical stirrer, temperature control, heating mantle and vacuum pump is charged with 388.13 g of aqueous 40% polymethacrylic acid (PMA; containing about 1.8 mol of carboxylic acid groups) having an average molecular weight of 5,000. 349.3 g (0.35 mol) of polyether (MPEG 1000, INEOS), 0.03 g of defoamer (Foamex 1488, Evonik Tego Chemie GmbH) and, with stirring, 5.46 g 37% (20.6 mmol) sulfuric acid are added. The reaction mixture is heated to 175° C., thereby distilling off the water. After stirring for 30 minutes at this temperature additional 232.9 g (0.23 mol) of MPEG 1000 are added all at once to the reaction mixture. Within minutes, a mixture consisting of 6.47 g of Jeffamine M2070 (Huntsman) and 6.5 g of the 50% base are added cautiously. Once the reaction mixture has again reached 175° C., the reaction is carried out to the desired conversion at a reduced pressure of 80 mbar. The melt is diluted with water to a solids content of 40-50%.

The base was added dropwise to the reaction mixture as a 50% solution in water. About 3.35 mol % base was used, based on the carboxyl groups of the PMA. When using NaOH, the amount of base used was 81.2 mmol (about 4.5 mol %). The bases used are shown in Table 1. Solubility and melting point are considered in the selection of the base. The table shows that the bases have a good solubility or a suitable melting point, to be used in sufficient quantity. The pH value of the reaction mixture after addition of the base is between about 3.5 and 4.5

TABLE 1
Overview of bases used including melting point and water solubility at
25° C. and 80° C. The abbreviation “c.s.” stands for completely soluble.

| | | | | Water | Water |
|---|---|---|---|---|---|
| | | | | solubility | solubility |
| | | | Mp. | about 25° C. | about 80° C. |
| Example | Base | Cation | [° C.] | [g/l] | [g/l] |
| 1 | Hydroxide | Na | 322 | 1260 | |
| 2 | Hydroxide | K | 360 | 1120 | |
| 3 | Formate | Na | 260 | 972 | 1600 |
| 4 | Formate | K | 168 | 3310 | 6570 |
| 5 | Acetate | Na | 58*/324 | 762 | |
| 6 | Acetate | K | 292 | 2560 | 4920 |
| 7 | Acetate | Mg | 323 | c.s. | c.s. |
| 8 | Rhodanide | Na | 287 | 1250 | |
| 9 | Rhodanide | K | 175 | 208 | |
| 10 | Carbonate | Na | 160** | 217 | |
| 11 | Carbonate | K | 891 | 1120 | |

### Examples 12 to 17

### Degree of Esterification of Polymethacrylic Acid Using Various Bases

The degree of esterification of polymethacrylic acid having an average molecular weight of 5000 was determined after a reaction time 30, 60, 90, and 120 min, respectively. The results are shown in Table 2 and FIG. 1. With the addition of alkali metal salts to the reaction mixture a substantial improvement in terms of conversion can be observed.

Compared with sodium salts, potassium salts are slightly more efficient. Regarding the anions, the presence of acetate or formate results in a particularly efficient conversion. In the presence of these bases side reactions are suppressed.

TABLE 2
Results of examples 12 to 17. Example 12 is a reference example.

| | | | | Con- | Con- |
|---|---|---|---|---|---|
| | | Conversion | Conversion | version | version |
| | | [%] | [%] | [%] | [%] |
| Example | Base | 30 min | 60 min | 90 min | 120 min |
| 12 | none | 56 | 66 | 75 | 80 |
| 13 | NaOH | 75 | 86 | 91 | 93 |
| 14 | KOH | 70 | 81 | 87 | 90 |
| 15 | Potassium | 89 | 92 | 94 | — |
| | formate | | | | |
| 16 | Potassium | 89 | 92 | 96 | — |
| | acetate | | | | |
| 17 | Potassium | 77 | 86 | 91 | 93 |
| | rhodanide | | | | |

### Examples 18 to 20

### Esterification of Polyacrylic Acid Using Various Bases

An esterification reaction was carried out according to Examples 1 to 11, wherein polyacrylic acid (BASF, Sokalan PA25 CL PN, about 50% aqueous solution) was used instead of polymethacrylic acid. NaOH and potassium acetate were used as the bases. The results are shown in Table 3 and FIG. 2. Potassium is significantly more efficient than NaOH.

TABLE 3
Results of examples 18 to 20. Example 18 is a reference example.

| | | | | C [%] | C [%] |
|---|---|---|---|---|---|
| | | C [%] after | C [%] after | after | after |
| Example | Base | 30 min | 60 min | 90 min | 120 min |
| 18 | none | 74 | 88 | 92 | 95 |
| 19 | NaOH | 80 | 89 | 93 | — |
| 20 | Potassium | 87 | 95 | — | — |
| | acetate | | | | |

### Examples 21 to 24

### Esterification of Polyacrylic Acid with and without Sulfuric Acid

An esterification reaction was carried out according to Examples 1 to 11, wherein polyacrylic acid was used instead of polymethacrylic acid. NaOH and potassium acetate were used as the bases. One experiment was carried out with NaOH, where no sulfuric acid was added.

The results are shown in Table 4 and FIG. 3. The results show that compared to NaOH the neutralization with potassium acetate is significantly more efficient. The sulfuric acid added to the reaction acts as a solubilizer between MPEG and polymethacrylic acid. If sulfuric acid is omitted (Ex. 23), the reaction rate increases, because more NaOH is available for neutralization. In exchange, however, inhomogeneities during the reaction are to be expected, which in turn may adversely affect the rate and feasibility.

TABLE 4
Results of examples 21 to 24. Example 21 is a reference example.

| | | | | C [%] | C [%] |
|---|---|---|---|---|---|
| | | C [%] after | C [%] after | after | after |
| Example | Base | 30 min | 60 min | 90 min | 120 min |
| 21 | none | 76 | 87 | 92 | 96 |
| 22 | NaOH | 89 | 96 | 98 | — |
| 23 | NaOH/ | 93 | 98 | — | — |
| | no H₂SO₄ | | | | |
| 24 | Potassium | 95 | 99 | — | — |
| | acetate | | | | |

### Example 25 (Reference Example)

### Procedure for Adding the Base Before Heating

A 1000 ml reaction vessel equipped with a mechanical stirrer, temperature control, heating mantle and vacuum pump is charged with 388.13 g of aqueous 40% polymethacrylic acid. 349.3 g (3/5 of the theoretical amount) of MPEG 1000, 0.03 g of defoamer and, with stirring, 5.46 g of 37% sulfuric acid and 10.3 g potassium formate (66% solution) in water are added. The reaction mixture is heated, thereby distilling off the water. At a temperature of 135° C., the polymethacrylic acid is precipitating and a two-phase mixture is formed that no longer can be stirred. The precipitated polymethacrylic acid could then no longer be dissolved homogenously in MPEG 1000. Performing an esterification reaction was not possible.

### Example 26

### Procedure for Adding the Base after Heating

A 1000 ml reaction vessel equipped with a mechanical stirrer, temperature control, heating mantle and vacuum pump is charged with 388.13 g of aqueous 40% polymethacrylic acid. 349.3 g (3/5 of the theoretical amount) of MPEG 1000, 0.03 g of defoamer and, with stirring, 5.46 g of 37% sulfuric acid are added. The reaction mixture is heated thereby distilling off the water. When the reaction mixture has reached about 140° C., this temperature is maintained for 30 minutes. Then, 232.9 g of MPEG are added (2/5 of the theoretical amount) all at once, and the temperature is brought up again to 140° C. Then, 10.3 g potassium formate as a 66% solution in water and Jeffamine M 2070 are added. Then, the temperature is raised to 175° C. and the reaction is carried out to the desired conversion at a reduced pressure of 80 mbar. Then, the polymer melt is cooled to 100° C. and diluted with water to a solids content of 50%.

Polymer conversion by reaction time:

30 min: 86%

60 min: 92%

90 min: 94%

120 min: 96%

The comparison with Example 25 shows the advantages of the method according to the invention.

### Example 27

### Hydrolytic Stability of Comb Polymers

The hydrolytic stability of various comb polymers was examined. In this context, 1 g of comb polymer (solid) was dissolved in 10 ml 2 N of sodium hydroxide. The sample is allowed to stand, and every 30 minutes an aliquot of about 100 mg is removed and mixed with 4 drops of 1 N HCl. The sample is then diluted such that 2-3 mg of polymer/ml are present in the sample. Then, by means of UPLC (Ultra Performance Liquid Chromatography) alcohol (MPEG) cleaved from the polymer is measured. Prior, a calibration curve for the polymer and for the alcohol (MPEG) is created.

UPLC parameters:
Instrument: Acquity UPLC with UV and light scattering detector (Waters, USA)
Column: Acquity UPLC BEH300 C18 1.7 μm 2.1×100 mm (Waters)
Eluents:
   A: 0.15% formic acid in water,
   B: acetonitrile

The result is shown in FIG. 4. It is apparent that the alkali content has an influence on the rate of hydrolysis of the polymers. A sample without alkalis hydrolyzes faster and about 5% more than samples containing alkalis. The reference was prepared with 4 g of NaOH (50%)/mol acid. If more alkalis are added (2×, 4× the amount), the hydrolysis kinetics changes minimally. The hydrolysis stops at a 2-3% higher level. The results show that using alkali-carboxylic acids a comb polymer is obtained that is more stable to hydrolytic degradation.

1. A method for producing comb polymers, wherein at least one polycarboxylic acid or a salt thereof is esterified with at least one monohydroxy polyether, comprising the following steps:
(a) preparing a reaction mixture containing at least one polycarboxylic acid;
(b) heating the reaction mixture to at least 80° C., particularly at least 100° C.;
(c) adding a base; and
(d) esterifying at a reaction temperature of at least 80° C., particularly at least 100° C., obtaining a comb polymer,
wherein at least one monohydroxy polyether is added to the reaction mixture in step (a) and/or (b).

2. The method according to claim 1, wherein the polycarboxylic acid in the reaction mixture in step (a) is not or substantially not present in neutralized form.

3. The method according to claim 1, wherein the base is added in an amount which causes a partial neutralization of the polycarboxylic acid

4. The method according to claim 1, wherein prior to the heating in step (b) an acid, in particular sulfuric acid or p-toluenesulfonic acid is added to the reaction mixture of step (a), wherein the acid is added in an amount such that the polycarboxylic acid is not or substantially not present in neutralized form.

5. The method according to claim 1, wherein the polycarboxylic acid is polyacrylic acid, polymethacrylic acid or a copolymer of acrylic acid and methacrylic acid.

6. The method according to claim 1, wherein the monohydroxy polyether E has the formula (I)
HO—(R3O)x-R4 (I),
wherein each of R3 is independently a C2-C4 alkylene group with an order of the (R3O) moieties in any sequence, wherein R4 is a C1-C12 alkyl or cycloalkyl radical, a C7-C20 alkylaryl or aralkyl radical, or a substituted or unsubstituted aryl radical, or a monovalent organic radical having 1 to 30 carbon atoms which optionally comprises heteroatoms; and wherein x is a number from 3 to 250, preferably 5 to 200.

7. The method according to claim 1, wherein the esterification, optionally in conjunction with an amidation, is carried out by the reaction of
a) at least one polycarboxylic acid or a salt of said polycarboxylic acid;
b) at least one monohydroxy compound E of the formula (I)
HO—(R3O)x-R4 (I)
and optionally at least one additional monoamine compound F of the formula (II)
NH2-(R3O)x-R4 (II)
wherein x, R3 and R4 are independently selected as specified above

8. The method according to claim 1, wherein the reaction mixture, in addition to the base polymer, contains the following components, based on 1 mol of carboxyl groups of the base polymer:
(a) 0.05 to 0.8 mol of monohydroxy polyether,
(b) optionally 0 to 0.5 mol of amine,
(c) 10 to 250 mmol of additional base; and
(d) optionally 0 to 100 mmol additional acid.

9. The method according to claim 1, wherein the comb polymer has a degree of esterification of the base polymer between 5% and 80%.

10. The method according to claim 1, wherein the base is selected from metal carboxylates, metal hydroxides, metal carbonates, thiocyanates and phosphites.

11. The method according to claim 10, wherein the metal is an alkali metal or alkaline earth metal, particularly sodium or potassium and/or the carboxylate is a carbonate, formate, acetate, propionate, citrate, adipate, maleate or tartrate.

12. The method according to claim 1, wherein the base is a metal carboxylate, and wherein the carboxylate is removed by distillation during or after the esterification in the form of the carboxylic acid

13. A comb polymer-containing composition obtainable by a method according to claim 1.

14. A hydraulically setting cement composition comprising at least one comb polymer-containing composition according to claim 13, and at least one hydraulically setting binder.

15. A molded body obtainable by setting and curing of a cement composition according to claim 14.

16. The use of a comb polymer-containing composition according to claim 13 for plasticizing hydraulically setting cement compositions.
